(19) United States
(12) Patent Application Publication
(10) Pub. No.: US 2006/0135387 A1
(43) Pub. Date: Jun. 22, 2006

(54) Bleaching composition

(76) Inventors: Adrianus Cornelis Van Asten, Vlaardingen (NL); Maartje Ouwendijk-Vrijenhoek, Vlaardingen (NL); Simon Veerman, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/559,964

(22) PCT Filed: Apr. 28, 2004
(86) PCT No.: PCT/EP04/04799

§ 371 Date: Dec. 8, 2005

(30) Foreign Application Priority Data
Jun. 9, 2003 (GB) 0313249.5

(51) Int. Cl. C11D 3/395

(52) U.S. Cl. 510/302

(57) ABSTRACT

The present invention concerns the preservation of a perfume components in a bleaching composition. The bleaching composition is substantially devoid of a peroxygen bleach or a peroxy-based or peroxyl-generating bleach system.

### FIELD OF INVENTION

This invention relates to the enhancement of bleaching compositions that are substantially devoid of peroxyl species.

### BACKGROUND OF INVENTION

The use of bleaching catalysts for stain removal has been developed over recent years. The recent discovery that some catalysts are capable of bleaching effectively in the absence of an added peroxyl source has recently become the focus of some interest, for example: WO9965905; WO0012667; WO0012808; WO0029537, and, WO0060045.

The shelf life of a product may be regarded as the period of time over which the product may be stored whilst retaining its required quality. A satisfactory shelf life is in many instances a crucial factor for the success of a commercial product. A product with a short shelf life generally dictates that the product is made in small batches and is rapidly sold to the consumer. It is also a concern to the owners of a brand with a short shelf life that the consumer uses the product within the shelf life otherwise the consumer may be inclined to change to a similar product of another brand. In contrast a similar product with a long shelf life may be made in larger batches, held as stock for a longer period of time and the period of time that a consumer stores the product is not of a great concern to the owners of a particular brand.

It is an object of the present invention to provide an air bleaching composition that has improved storage properties.

### SUMMARY OF INVENTION

We have found that some components degrade per se and/or reduce the activity of bleaching catalysts over a period of time. We have found that by carefully selecting certain components the stability of a bleaching composition, which is substantially devoid of a peroxygen bleach or a peroxy-based or peroxyl-generating bleach system, is improved. The present invention has particular utility in commercial liquid bleaching compositions.

The present invention provides a bleaching composition comprising:

(a) an organic substance which forms a complex with a transition metal for bleaching a substrate with atmospheric oxygen, the bleaching composition upon addition to an aqueous medium providing an aqueous bleaching medium substantially devoid of a peroxygen bleach or a peroxy-based or peroxyl-generating bleach system,

(b) between 0.001 to 3 wt/wt % of a perfume composition said perfume composition comprising at least 0.01 wt % of an ketonic perfume, and

(c) an antioxidant in the range from 0.0001 to 20 wt/wt %,

(d) the balance carriers and adjunct ingredients to 100 wt/wt % of the total bleaching composition.

The term “substantially devoid of a peroxygen bleach or a peroxy-based or peroxyl-generating bleach system” should be construed within spirit of the invention. It is preferred that the composition has as low a content of peroxyl species present as possible. It is preferred that the bleaching formulation contains less that 1% wt/wt total concentration of peracid or hydrogen peroxide or source thereof, preferably the bleaching formulation contains less that 0.3 % wt/wt total concentration of peracid or hydrogen peroxide or source thereof, most preferably the bleaching composition is devoid of peracid or hydrogen peroxide or source thereof. In addition, it is preferred that the presence of alkyl hydroperoxides is kept to a minimum in a bleaching composition comprising the ligand or complex of the present invention.

The present invention extends to a method of bleaching a substrate/textile with a composition of the present invention. The method comprising the steps of treating a substrate with the bleaching composition in an aqueous environment, rinsing the substrate and drying the substrate.

The present invention also extends to a commercial package together with instructions for its use.

### DETAILED DESCRIPTION OF THE INVENTION

Antioxicant

The bleaching compositions of the present invention will comprise an effective amount of the antioxidant. An effective amount of an antioxidant is in the range 0.001 to 20 wt/wt % depending upon the nature of the antioxidant and subsidiary purpose of the antioxidant, for example as a carrier or solvent. Preferably the antioxidant is present in the range from 0.001 to 2 wt/wt %. When a phenolic antioxidant is present it is preferred that the phenolic antioxidant present in the range from 0.0001 to 3 % wt % of the composition. When an amine antioxidant it is present it is preferred that the phenolic antioxidant present in the range from 0.0001 to 20 % wt % of the composition.

Anti-oxidants are substances as described in Kirk-Othmers (Vol 3, pg 424) and in Uhlmans Encyclopedia (Vol 3, pg 91).

One class of anti-oxidants suitable for use in the present invention is alkylated phenols having the general formula: 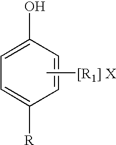
wherein R is C1-C22 linear or branched alkyl, preferably methyl or branched C3-C6 alkyl; C3-C6 alkoxy, preferably methoxy; R1 is a C3-C6 branched alkyl, preferably tert-butyl; x is 1 or 2. Hindered phenolic compounds are preferred as antioxidant.

Another class of anti-oxidants suitable for use in the present invention is a benzofuran or benzopyran derivative having the formula: 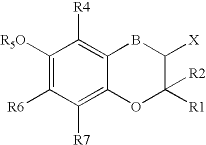
wherein R1 and R2 are each independently alkyl or R1 and R2 can be taken together to form a C5-C6 cyclic hydrocarbyl moiety; B is absent or CH2; R4 is C1-C6 alkyl; R5 is hydrogen or —C(O)R3 wherein R3 is hydrogen or C1-C19 alkyl; R6 is C1-C6 alkyl; R7 is hydrogen or C1-C6 alkyl; X is —CH2OH, or —CH2A wherein A is a nitrogen comprising unit, phenyl, or substituted phenyl. Preferred nitrogen comprising A units include amino, pyrrolidino, piperidino, morpholino, piperazino, and mixtures thereof.

Other suitable antioxidants are found as follows. A derivative of α-tocopherol, beta-tocopherol, gamma-tocopherol, delta-tocopherol, 6-hydroxy-2,5,7,8-tetra-methylchroman-2-carboxylic acid (Trolox™).

Anti-oxidants/radical scavengers such as ascorbic acid (vitamin C) and its salts, tocopherol (vitamin E), tocopherol sorbate, other esters of tocopherol, butylated hydroxy benzoic acids and their salts, gallic acid and its alkyl esters, especially propyl gallate, uric acid and its salts and alkyl esters, sorbic acid and its salts, the ascorbyl esters of fatty acids, amines (e.g., N,N-diethylhydroxylamine, amino-guanidine, amine alcohols), sulfhydryl compounds (e.g., glutathione), and dihydroxy fumaric acid-and its salts may be used.

Non-limiting examples of anti-oxidants suitable for use in the present invention include phenols inter alia 2,6-di-tert-butylphenol, 2,6-di-tert-butyl-4-methylphenol, mixtures of 2 and 3-tert-butyl-4-methoxyphenol, and other ingredients including include propyl gallate, tert-butylhydroquinone, benzoic acid derivatives such as methoxy benzoic acid, methylbenzoic acid, dichloro benzoic acid, dimethyl benzoic acid, 5-hydroxy-2,2,4,6,7-pentamethyl-2,3-dihydro-1-benzofuran-3-one, 5-hydroxy-3-methylene-2,2,4,6,7-pentamethyl-2,3-dihydro-benzofuran, 5-benzyloxy-3-hydroxymethyl-2,2,4,6,7-pentamethyl-2,3-dihydro-1-benzofuran, 3-hydroxymethyl-5-methoxy-2,2,4,6,7-pentamethyl-2,3-dihydro-1-benzofuran, vitamin C(ascorbic acid), and Ethoxyquine (1,2-dihydro-6-ethoxy-2,2,4-trimethylchinolin)marketed under the name Raluquin™ by the company Raschig™.

Preferred antioxidants for use herein include 2,6-di-tert-butyl hydroxy toluene (BHT), α-tocopherol, hydroquinone, 2,2,4-trimethyl-1,2-dihydroquinoline, 2,6-di-tert-butyl hydroquinone, 2-tert-butyl hydroquinone, tert-butyl-hydroxy anisole, lignosulphonic acid and salt thereof, benzoic acid and derivatives thereof, like alkoxylated benzoic acids, as for example, trimethoxy benzoic acid (TMBA), toluic acid, catechol, t-butyl catechol, benzylamine, amine alcohols, 1,1,3-tris(2-methyl-4-hydroxy-5-t-butylphenyl) butane, N-propyl-gallate or mixtures thereof and highly preferred is di-tert-butyl hydroxy toluene. Of the amine alcohols 2-amino-2-methyl-1-propanol, tri-ethanol amine, tri-methanol amine, mono-ethanol amine, diethanol amine, are preferred.

Mixtures of antioxidants may be use and in particular mixtures that have synergic antioxidant effects as found in, for example, WO02/072746.

Ketonic Purfumes

The bleaching composition of the present invention comprises between 0.001 to 3 wt/wt % of a perfume composition, preferably between 0.1 to 2 wt/wt % of a perfume composition. The perfume composition may be 100% ketonic perfume but generally the perfume composition is a complex mixture of perfumes of other differing perfume classifications, for example terpenes and aldehydes; in this regard, the perfume composition comprises at least 0.01 wt % of a ketonic perfume. At higher levels of ketonic perfume the greater the importance of the antioxidant, for example at least 0.1, 1.0 wt % and 5 wt % of a ketonic perfume component of the perfume composition. The present invention has particular utility with, but not limited to, the following ketonic perfume components. 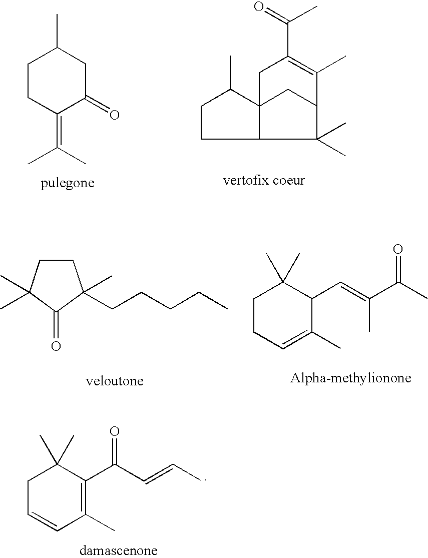
The Bleach Catalyst

Recently we have found that oily stains are bleached in the presence of selected transition metal catalysts in the absence of an added peroxyl source. The bleaching of an oily stain in the absence of an added peroxyl source has been attributed to oxygen derived from the air. Whilst it is true that bleaching is effected by oxygen sourced from the air the route in which oxygen plays a part is becoming understood. In this regard, the term “air bleaching” is used.

We have concluded from our research that bleaching of a chromophore in an oily stain is effected by products formed by adventitious oxidation of components in the oily stain. These products, alkyl hydroperoxides, are generated naturally by autoxidation of the oily stain and the alkyl hydroperoxides together with a transition metal catalyst serve to bleach chromophores in the oily stain. Alkyl hydroperoxides (ROOH) are generally less reactive that other peroxy species, for example, peracids (RC(O)OOH), hydrogen peroxide (H2O2), percarbonates and perborates. In this regard, the phrase “for bleaching a substrate with atmospheric oxygen” is synonymous with “for bleaching a substrate via atmospheric oxygen” because it is the oxygen in the air that provides the bleaching species used by catalyst to bleach the substrate stain.

The bleach catalyst per se may be selected from a wide range of transition metal complexes of organic molecules (ligands). In typical washing compositions the level of the organic substance is such that the in-use level is from 0.05 μM to 50 mM, with preferred in-use levels for domestic laundry operations falling in the range 1 to 100 μM. Higher levels may be desired and applied in industrial textile bleaching processes.

Suitable organic molecules (ligands) for forming complexes and complexes thereof are found, for example in:

GB 9906474.3; GB 9907714.1; GB 98309168.7, GB 98309169.5; GB 9027415.0 and GB 9907713.3;

DE 19755493; EP 999050; WO-A-9534628; EP-A-458379;

EP 0909809; U.S. Pat. No. 4,728,455;

WO-A-98/39098; WO-A-98/39406, WO 9748787, WO 0029537;

WO 0052124, and WO0060045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane).

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

An example of a preferred catalyst is a monomer ligand or transition metal catalyst thereof of a ligand having the formula (I):

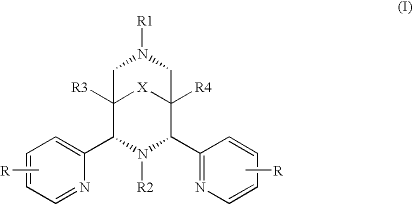

wherein each R is independently selected from: hydrogen, F, Cl, Br, hydroxyl, C1-C4-alkylO—, —NH—CO—H, —NH—CO—C1-C4-alkyl, —NH2, —NH—C1-C4-alkyl, and C1-C4-alkyl;

R1 and R2 are independently selected from:

C1-C4-alkyl,

C6-C10-aryl, and,

a group containing a heteroatom capable of coordinating to a transition metal, wherein at least one of R1 and R2 is the group containing the heteroatom;

R3 and R4 are independently selected from hydrogen, C1-C8 alkyl, C1-C8-alkyl-O—C1-C8-alkyl, C1-C8-alkyl-O—C6-C10-aryl, C6-C10-aryl, C1-C8-hydroxyalkyl, and —(CH2)ₙC(O)OR5 wherein R5 is independently selected from: hydrogen, C1-C4-alkyl, n is from 0 to 4, and mixtures thereof; and,

X is selected from C═O, —[C(R6)₂]_{y}- wherein Y is from 0 to 3 each R6 is independently selected from hydrogen, hydroxyl, C1-C4-alkoxy and C1-C4-alkyl.

The transition metal complex preferably is of the general formula (AI):
[MₐLₖXₙ]Yₘ
in which:

M represents a metal selected from Mn(II)-(III)-(IV)-(V), Cu(I)-(II)-(III), Fe (II)-(III)-(IV)-(V), (V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

Balance Carriers and Adjunct Ingredients

These are generally surfactants, builders, foam agents, anti-foam agents, solvents, and enzymes. The use and amounts of these components are such that the bleaching composition performs depending upon economics, environmental factors and use of the bleaching composition.

The air bleach catalyst may be used in a detergent composition specifically suited for stain bleaching purposes, and this constitutes a second aspect of the invention. To that extent, the composition comprises a surfactant and optionally other conventional detergent ingredients. The invention in its second aspect provides an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

One skilled in the art will appreciate that some adventitious peroxyl species may be in the composition nevertheless it is most preferred that the bleaching composition of the present invention has less that 1%, preferably less than 0.1%, most preferably less than 0.01%, of a peroxyl species present. These adventitious peroxyl are predominantly alkyl hydroperoxides formed by autoxidation of the surfactants.

The detergent composition may take any suitable physical form, such as a powder, granular composition, tumble dryer sheet, tablets, a paste or an anhydrous gel.

The composition may contain additional enzymes as found in WO 01/00768 A1 page 15, line 25 to page 19, line 29, the contents of which are herein incorporated by reference.

Builders, polymers and other enzymes as optional ingredients may also be present as found in WO0060045.

Suitable detergency builders as optional ingredients may also be present as found in WO0034427.

The composition of the present invention may be used for laundry cleaning, hard surface cleaning (including cleaning of lavatories, kitchen work surfaces, floors, mechanical ware washing etc.). As is generally known in the art, bleaching compositions are also employed in waste-water treatment, pulp bleaching during the manufacture of paper, leather manufacture, dye transfer inhibition, food processing, starch bleaching, sterilisation, whitening in oral hygiene preparations and/or contact lens disinfection.

In the context of the present invention, bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

Liquid Formulation

The present invention has particular utility for liquid formulations because in contrast to a solid heterogeneous mixture in a liquid formulation the contact between individual components are more intimate and hence more susceptible to degradation due to interaction of components.

There are many commercial liquid formulations for detergents and rinse conditioners or other liquid products that may be enhanced by conferring a bleaching ability to the liquid formulation. As will be evident to one skilled in the art the present invention is applicable to known liquid formulations and liquid formulations to be developed.

The level of the catalyst in a commercial bleaching composition is from 0.0001 to 0.6 wt/wt %, preferably 0.001 to 0.15 wt/wt %, most preferably 0.01 to 0.1 wt/wt %. We have found that the level of catalyst is optimum between 0.03 to 0.09 wt/wt % in the commercial bleaching composition.

The present invention extends to both isotropic and complex liquid compositions and formulations a brief discussion of which follows. Some isotropic formulations are termed ‘micro-emulsion’ liquids that are clear and thermodynamically stable over a specified temperature range. The ‘micro-emulsion’ formulation may be water in oil, or oil in water emulsions. Some liquid formulations are macro-emulsions that are not clear and isotropic. Emulsions are considered meta-stable. Concentrated, clear compositions containing fabric softening actives have been disclosed in WO 98/08924 and WO 98/4799, both Procter & Gamble. Such compositions comprise biodegradable fabric conditioners. However, both disclose compositions comprising water miscible solvents that do not form water-in-oil micro-emulsions. Clear fabric conditioning compositions have also been disclosed in EP 730023 (Colgate Palmolive), WO 96/19552 (Colgate Palmolive), WO 96/33800 (Witco Co.), WO 97/03170 (Procter & Gamble), WO 97/03172 (Procter & Gamble), WO 97/03169 (Procter & Gamble), U.S. Pat. No. 5,492,636 (Quest Int.) and U.S. Pat. No. 5,427,697 (Procter & Gamble). Liquid formulations of the present invention may contain for example; monoethoxy quats; AQAs and bis-AQAs; cationic amides; cationic esters; amino/diamino quats; glucamide; amine oxides; ethoxylated polyethyleneimines; enhancement polymers of the form linear amine based polymers, e.g. bis-hexamethylenetriamine; polyamines e.g. TETA, TEPA or PEI polymers.

The liquid may be contained within a sachet as found in WO02/068577.

The following is an example of a liquid bleaching composition to which an organic substance which forms a complex with a transition metal for bleaching a substrate with atmospheric oxygen may be added together further antioxidant if required. The perfume composition as found in the following example comprising at least 0.01 wt % of an ketonic perfume.

| Ingredient | Wt % |
|---|---|
| Nonionic surfactant | 26.6 |
| Monopropylene glycol | 5.5 |
| Pigment premix | 0.017 |
| Glycerol | 21.36 |
| Monoethanolamine | 7.56 |
| Oleic fatty acid | 13.10 |
| Water | Up to 100 |
| Linear alkyl benzene sulfonate | 20.1 |
| Perfume | 1.6 |
| Protease Enzyme | 1.0 |

The following are further examples of commercial liquid formulations that the present invention may be incorporated into: Wisk™ liquid USA, 1999, OMO™ liquid NL, 1999, OMO-liquido™ Brazil, 1999, and Rinse conditioner (Robijn™-NL). In this regard, that catalyst is added and the level of antioxidant adjusted together with the perfume composition.

The following is a further example of a commercial liquid formulation that the present invention may be incorporated into by adding the catalyst and the appropriate level of antioxidant and perfume composition. The commercial liquid formulation has a pH of 7.

| | |
|---|---|
| Sodium citrate: | 3.2% |
| Polypropylene glycol: | 4.75% |
| LAS-acid: | 5.6% |
| NI 25 9 EO: | 6.6% |
| LES (anionic sufactant): | 10.5% |
| Borax: | 2.30% |
| Sorbitol: | 3.35% |
| Alcosperce 725: | 0.30% |
| Coconut fatty acid: | 0.73% |
| monoethanolamine: | 0.20% |
| fluorescer: | 0.125% |
| savinase/lipex | |
| perfume/dye | |

It is most preferred that when the catalyst is in a liquid composition, the liquid composition has a pH of 7 or below irrespective of whether perfumes and/or antioxidants are present or not.

Experimental

The following catalyst (bleach component) was used in the experiments 9,9-dihydroxy-2,4-di-(2-pyridyl)-3-methyl-7-(pyridin-2-ylmethyl)-3,7-diaza-bicyclo[3.3.1]nonane-1,5-dicarboxylate Iron (II) dichloride was prepared as described by Heidi Borzel, Peter Comba, Karl S. Hagen, Yaroslaw D. Lampeka, Achim Lienke, Gerald Linti, Michael Merz, Hans Pritzkow, Lyudmyla V. Tsymbal in Inorganica Chimica Acta 337 (2002) 407-419. WO0248301 provides synthetic details of similar compounds.

Liquid compositions containing 0.06% wt/wt of a bleach component and 0.03 to 0.06% wt/wt of individual perfume components are stored in glass vials for 14 days at 37° C. in a cabinet.

The activities of the bleach component were determined at 40° C. in a H2O2 containing NaH2PO4.H2O pH7 buffer and Acid Blue 45 (CAS No. 2861-02-1) as substrate using the following protocol.

Samples of 70 mg liquid were diluted in 10.00 ml MilliQ water. We added 45 μl of this solution to an assay of 230 μL containing 20 mM H2O2, 75 μM Acid blue 45 and 54 mM NaH2PO4.H2O pH7 buffer.

The solutions were mixed and pre-incubated for 1 min at 40° C. The changes in absorbance at 600 nm were measured for 8 min at 40° C. using a spectrophotometer.

The absolute changes in absorbance were correlated to activities obtained with freshly prepared calibration samples.

The following liquids compositions A and B were use for the perfume compatibility experiments in which made up to 100% with water.

Liquid composition A:

6% LAS

6% sLES 3 EO

6% Nonionic 7 EO

0.016% Antibacterial Agent

3.35% sorbitol

2.30% Borax.10 H2O

4.75% Mono propylene glycol

0.75% NaOH

0.4% Enzyme

pH 7

Liquid composition B:

6% LAS

6% sLES 3 EO

6% Nonionic 7 EO

0.016% Antibacterial Agent

3.35% sorbitol

2.30% Borax.10 H2O

4.75% Mono propylene glycol

0.75% NaOH

0.4% Enzymes

pH 7

TABLE 1
Influence of 0.06% perfume component and 0.05% BHT
on the stability of 0.03% bleach component in liquid
A after 3 weeks storage at 37° C.

| | Liquid A and no | Liquid A + 0.05% |
|---|---|---|
| Perfume component | BHT | BHT |
| (0.06%) | Activity (%) | Activity (%) |
| No perfume | 42 | — |
| component | | |
| Pulegone | 4 | 63 |
| Vertofix coeur | 13 | 64 |

TABLE 2
Influence of 0.06% perfume component and 0.05% BHT
on the stability of 0.03% bleach component in liquid
B after 3 weeks storage at 37° C.

| | Liquid B and no | Liquid B + 0.05% |
|---|---|---|
| Perfume component | BHT | BHT |
| (0.06%) | Activity (%) | Activity (%) |
| No Perfume | 45 | — |
| component | | |
| Pulegone | 3 | 72 |
| alpha methylionone | 28 | 66 |

TABLE 3
influence of 0.05% BHT on the stability of 0.06% perfume component
in liquid B after 2 weeks storage at 37° C.

| | | Liquid B + | Liquid B + |
|---|---|---|---|
| | | 0.03% bleach | 0.03% bleach |
| Perfume | | catalyst A and | catalyst A and |
| component | Liquid B | no BHT. | 0.05% BHT. |
| (0.06%) | Activity (%) | Activity (%) | Activity (%) |
| Pulegone | 82 | 50 | 88 |
| alpha | — | 64 | 74 |
| methylionone | | | |

1. A bleaching composition comprising:
(a) an organic substance which forms a complex with a transition metal for bleaching a substrate with atmospheric oxygen, the bleaching, composition upon addition to an aqueous medium providing an aqueous bleaching medium substantially devoid of a peroxygen bleach or a peroxy-based or peroxyl-generating bleach system,
(b) between 0.001 to 3 wt/wt % of a perfume composition said perfume composition comprising at least 0.01 wt % of an ketonic perfume, and
(c) an antioxidant in the range from 0.0001 to 20 wt/wt %,
(d) the balance carriers and adjunct ingredients to 100 wt/wt % of the total bleaching composition.

2. A bleaching composition according claim 1, wherein the antioxidant is selected from:
(i) an phenolic antioxidant, the phenolic antioxidant present in the range 0.0001 to 3 % wt %; and,
(ii) an amine antioxidant, the amine antioxidant in the range from 0.0001 to 20%.

3. A bleaching composition according claim 2, wherein the amine antioxidant is an amine alcohol.

4. A bleaching composition according to claim 3, wherein the amine alcohol is selected from the group consisting of: 2-amino-2-methyl-1-propanol, tri-ethanol amine, tri-methanol amine, mono-ethanol amine, diethanol amine, and methylanthranilate.

5. A bleaching composition according to claim 2, wherein the antioxidant is a hindered phenol.

6. A bleaching composition according to claim 5, wherein the antioxidant is selected from the group consisting of: 2,6-di-tert-butyl hydroxy toluene, α-tocopherol, Ethoxyquine and 6-hydroxy-2,5,7,8-tetra-methylchroman-2-carboxylic acid, and lignosulphonic acid.

7. A bleaching composition according to claim 6, wherein the antioxidant is 2,6-di-tert-butyl hydroxy toluene.

8. A bleaching composition according to claim 1, wherein the antioxidant is ascorbic acid.

9. A bleaching composition according to claim 5, wherein the antioxidant is present in the bleaching composition in the range from 0.001 to 2 wt %.

10. A bleaching composition according to claim 1, wherein the bleaching composition is a liquid.

11. A bleaching composition according to claim 1, comprising between 0.1 to 2 wt/wt % of a perfume composition.

12. A bleaching composition according to claim 1, wherein said perfume composition comprises at least 0.1 wt % of a ketonic perfume.

13. A bleaching composition according to claim 12, wherein said perfume composition comprises at least 1.0 wt % of a ketonic perfume.

14. A bleaching composition according to claim 13, wherein the perfume composition comprises at least 5 wt % of a ketonic perfume.

15. A bleaching composition according to claim 1, wherein the bleaching composition is a solid bleaching composition.

16. A bleaching composition according to claim 1, wherein the ketonic perfume is selected from the group consisting of: pulegone, vertofix coeur, veloutone, alpha-methylionone, and damascenone.

17. A method of bleaching a textile stain, comprising the steps of treating a substrate with the bleaching composition as defined in claim 1 in an aqueous environment, rinsing the substrate and drying the substrate.
